(19) United States
(12) Patent Application Publication
(10) Pub. No.: US 2014/0062916 A1
(43) Pub. Date: Mar. 6, 2014

(54) TOUCH PANEL AND METHOD OF MANUFACTURING THE SAME AND DISPLAY DEVICE USING THE SAME

(71) Applicant: LG DISPLAY CO., LTD., Seoul (KR)

(72) Inventors: Sunggon HONG, Seoul (KR); Soon Kwang HONG, Daegu (KR); Jae Do LEE, Gumi-si (KR); Yonghee HAN, Paju-si (KR)

(73) Assignee: LG Display Co., Ltd., Seoul (KR)

(21) Appl. No.: 13/856,852

(22) Filed: Apr. 4, 2013

(30) Foreign Application Priority Data
Aug. 28, 2012 (KR) 10-2012-0094083
Mar. 26, 2013 (KR) 10-2013-0031857

(51) Int. Cl. G06F 3/041

(52) U.S. Cl. CPC G06F 3/041
USPC 345/173; 216/13; 216/18

(57) ABSTRACT

Disclosed is a touch panel which facilitates to realize a simplified structure owing to a flexible printed circuit film which is formed on only one surface of a substrate without being formed on the other surface of the substrate, and a method of manufacturing the same, and a display device using the same.

### CROSS REFERENCE TO RELATED APPLICATIONS

This application claims the benefit of the Korean Patent Application No. 10-2012-0094083 filed on Aug. 28, 2012 and the Korean Patent Application No. 10-2013-0031857 filed on Mar. 26, 2013, which are hereby incorporated by reference as if fully set forth herein.

### BACKGROUND

1. Field of the Disclosure

Embodiments of the present invention relate to a display device, and more particularly, to a touch panel applied to a display device.

2. Discussion of the Related Art

Display devices for displaying an image have been developed, for example, liquid crystal display (LCD) device, plasma display panel (PDP), organic light emitting display (OLED) device, and etc.

These display devices generally use an input means such as mouse or keyboard. However, in case of navigation, mobile phone and household appliances, a touch panel is widely applied, which allows a user to input information by directly touching a screen with a finger, a pen or the like while a user looks at a screen of the display device.

Hereinafter, a display device with a touch panel according to the related art will be described with reference to the accompanying drawings.

FIG. 1 schematically illustrates a related art display device.

As shown in FIG. 1, the related art display device may include a touch panel 1, a flexible printed circuit film (FPC film) 21 and 22, and a display panel 30.

The touch panel 1 may include a substrate 10, a first touch electrode 11, and a second touch electrode 12. The first touch electrode 11 is formed on one surface of the substrate 10, and the second touch electrode 12 is formed on the other surface of the substrate 10.

The FPC film 21 and 22 may be connected with the touch panel 1, wherein the FPC film 21 and 22 may transmit a touch signal of the touch panel 1 to a driver (not shown). In more detail, the FPC film 21 and 22 may include the first FPC film 21 and the second FPC film 22. The first FPC film 21 is connected with the first touch electrode 11, and the second FPC film 22 is connected with the second touch electrode 12. The first and second FPC films 21 and 22 have a fine wiring printed on a polymer film, whereby the touch signals of the touch electrodes 11 and 12 are transmitted through the fine wiring.

The display panel 30 may be a liquid crystal panel, a plasma display panel, or an organic light emitting display panel.

However, the related art display device may have the following disadvantages.

The first touch electrode 11 is formed on one surface of the substrate 10, and the second touch electrode 12 is formed on the other surface of the substrate 10. Thus, the FPC film 21 and 22 includes the first FPC film 21 connected with the first touch electrode 11 on one surface of the substrate 10, and the second FPC film 22 connected with the second touch electrode 12 on the other surface of the substrate 10.

According as the FPC film 21 and 22 includes the first FPC film 21 on one surface of the substrate 10, and the second FPC film 22 on the other surface of the substrate, a structure of the display device is complicated.

### SUMMARY

Accordingly, embodiments of the present invention are directed to a touch pane and a method of manufacturing the same, and a display device using the same that substantially obviate one or more problems due to limitations and disadvantages of the related art.

An aspect of embodiments of the present invention is directed to provide a touch panel in which a touch signal is transmitted through the flexible printed circuit film formed on only one surface of a substrate, and a method of manufacturing the same, and a display device using the same.

Additional advantages and features of embodiments of the invention will be set forth in part in the description which follows and in part will become apparent to those having ordinary skill in the art upon examination of the following or may be learned from practice of embodiments of the invention. The objectives and other advantages of embodiments of the invention may be realized and attained by the structure particularly pointed out in the written description and claims hereof as well as the appended drawings.

To achieve these and other advantages and in accordance with the purpose of embodiments of the invention, as embodied and broadly described herein, there is provided a touch panel comprising a substrate; a first touch electrode on a first surface of the substrate; and a second touch electrode on a second surface of the substrate; wherein the first touch electrode and the second touch electrode are both electrically connected to a same flexible printed circuit film.

In another aspect of an embodiment of the present invention, there is provided a method of manufacturing a touch panel comprising: forming a substrate; forming a first touch electrode on a first surface of the substrate; and forming a second touch electrode on a second surface of the substrate; wherein the first touch electrode and the second touch electrode are both electrically connected to a same flexible printed circuit film.

In another aspect of an embodiment of the present invention, there is provided a display device that may include a touch panel; a flexible printed circuit (FPC) film connected to the touch panel; and a display panel formed under the touch panel; wherein the touch panel includes: a substrate; a first touch electrode on a first surface of the substrate; and a second touch electrode on a second surface of the substrate; wherein the first touch electrode and the second touch electrode are both electrically connected to the same FPC film.

It is to be understood that both the foregoing general description and the following detailed description of embodiments of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 schematically illustrates a related art display device;

FIG. 2 is a cross sectional view illustrating a display device according to one embodiment;

FIG. 3 is a plane view illustrating a touch panel according to one embodiment;

FIGS. 4A and 4B are cross sectional views along A-A of FIG. 3 illustrating touch panels according to various embodiments;

FIGS. 5A and 5B are cross sectional views along B-B of FIG. 3 illustrating touch panels according to various embodiments;

FIGS. 6A and 6B are cross sectional views along C-C of FIG. 3 illustrating touch panels according to various embodiments;

FIG. 7 is a plane view illustrating a touch panel according to another embodiment;

FIG. 8 is a plane view illustrating a touch panel according to another embodiment;

FIGS. 9A and 9B are plane views illustrating a touch panel according to another embodiment;

FIGS. 10A and 10B are cross sectional views illustrating various embodiments along B-B of FIGS. 9A and 9B;

FIGS. 11A and 11B are cross sectional views illustrating various embodiments along C-C of FIGS. 9A and 9B;

FIGS. 12A to 12H are cross sectional views illustrating a method of manufacturing a touch panel according to one embodiment;

FIGS. 13A to 13G are cross sectional views illustrating a method of manufacturing a touch panel according to another embodiment;

FIGS. 14A to 14F are cross sectional views illustrating a method of manufacturing a touch panel according to another embodiment;

FIGS. 15A to 15F are cross sectional views illustrating a method of manufacturing a touch panel according to another embodiment;

FIGS. 16A to 16D are cross sectional views illustrating a method of manufacturing a touch panel according to another embodiment; and

FIG. 17 is a cross sectional view schematically illustrating a display device according to another embodiment.

### DETAILED DESCRIPTION

Hereinafter, embodiments of the present invention will be described in detail with reference to the accompanying drawings.

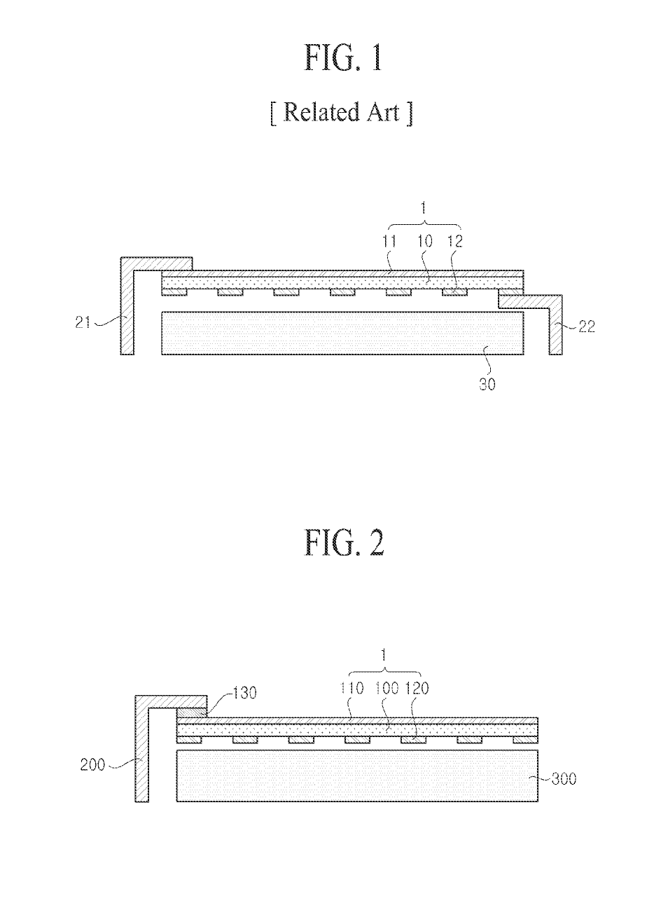

FIG. 2 is a cross sectional view illustrating a display device according to one embodiment of the present invention.

As shown in FIG. 2, the display device according to one embodiment may include a touch panel 1, a flexible printed circuit film (FPC film) 200, and a display panel 300.

The touch panel 1 may include a substrate 100, a first touch electrode 110, a second touch electrode 120, and an electrode pad 130.

The first touch electrode 110 is formed on one surface of the substrate 100, for example, an upper surface of the substrate 100. The second touch electrode 120 is formed on the other surface of the substrate 100, for example, a lower surface of the substrate 100.

The electrode pad 130 is electrically connected with the first touch electrode 110 and the second touch electrode 120. Also, the electrode pad 130 is brought into contact with the FPC film 200. Accordingly, touch signals sensed by the first touch electrode 110 and the second touch electrode 120 are transmitted to the FPC film 200 through the electrode pad 130.

The electrode pad 130 is formed on one surface of the substrate 100, for example, a peripheral area on the upper surface of the substrate 100, which makes it easy to electrically connect the first touch electrode 110 and the electrode pad 130 formed on the same surface of the substrate 100 with each other, but makes it difficult to electrically connect the second touch electrode 120 and the electrode pad 130 formed on the different surface of the substrate 100 with each other. The electrical connection between the second touch electrode 120 and the electrode pad 130 is performed through a contact hole formed inside the substrate 100, which will be described in detail below.

The FPC film 200 is connected with the touch panel 1, whereby the FPC film 200 transmits the touch signal of the touch panel 1 to a driver (not show). In more detail, the FPC film 200 is connected with the electrode pad 130, whereby the FPC film 200 is electrically connected with the first touch electrode 110 and the second touch electrode 120 through the electrode pad 130. As mentioned above, since the electrode pad 130 is formed on one surface of the substrate 100, the FPC film 200 is also formed on one surface of the substrate 100. Unlike the related art, there is no need to additionally form the FPC film on the other surface of the substrate 100, to thereby obtain a simplified structure of the touch panel 1.

The FPC film 200 may be obtained by printing a fine wiring on a flexible polymer film, wherein the fine wiring is electrically connected with the electrode pad 130. The FPC film 200 may be changed to various structures generally known to those in the art.

Also, various display panels generally known to those in the art may be applied to the display panel 300, for example, liquid crystal panel, plasma display panel, or organic light emitting display panel.

Hereinafter, the touch panel according to various embodiments of the present invention will be described in detail as follows.

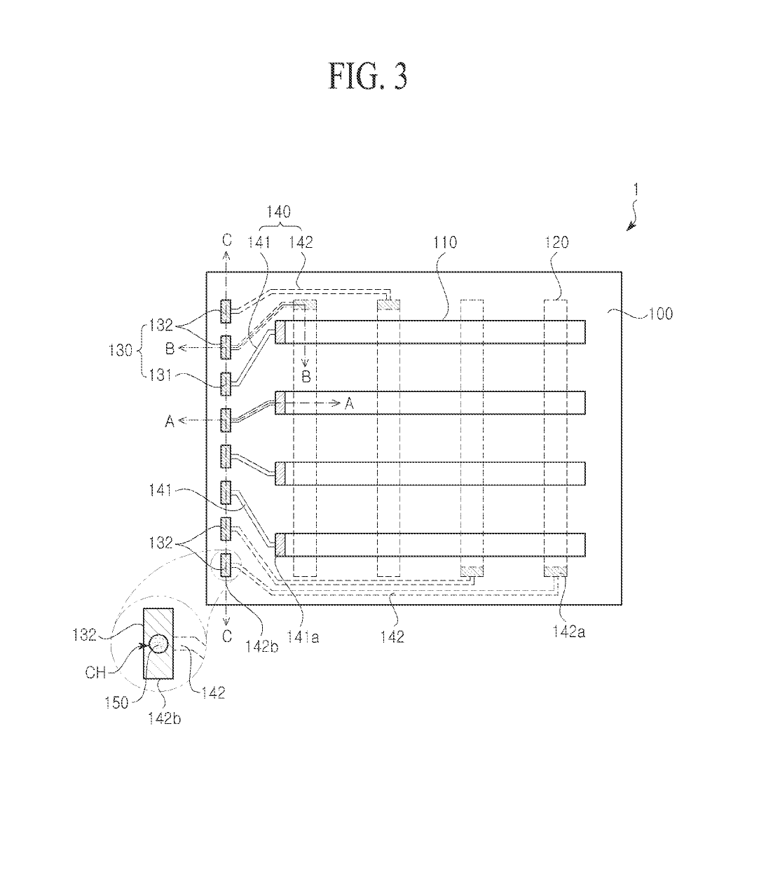

FIG. 3 is a plane view illustrating the touch panel 1 according to one embodiment of the present invention.

As shown in FIG. 3, the touch panel 1 according to one embodiment may include a substrate 100, a first touch electrode 110, a second touch electrode 120, an electrode pad 130, a connection line 140, and a contact electrode 150.

The substrate 100 may be formed of glass or transparent plastic.

The first touch electrode 110 is formed on one surface of the substrate 100, for example, an upper surface of the substrate 100, wherein the first touch electrode 110 may be formed in a bar shape extending along a longitudinal direction of the substrate 100. The plurality of first touch electrodes 110 may be provided at fixed intervals, to thereby form a plurality of rows. However, the first touch electrode 110 is not limited to the bar shape. The first touch electrode 110 may be changed to various shapes generally known to those in the art. Since the first touch electrode 110 is positioned in an active area for displaying an image, the first touch electrode 110 is formed of a transparent conductive material.

The second touch electrode 120 is formed on the other surface of the substrate 100, for example, a lower surface of the substrate 100. For convenience of explanation, elements formed on the upper surface of the substrate 100 are illustrated in solid lines, and elements formed on the lower surface of the substrate 100 are illustrated in dashed lines.

The second touch electrode 120 may be formed in a bar shape extending along a vertical direction of the substrate 100. The plurality of second touch electrodes 120 may be provided at fixed intervals, to thereby form a plurality of columns. However, the second touch electrode 120 is not limited to the bar shape. The second touch electrode 110 may be changed to various shapes generally known to those in the art. Since the second touch electrode 110 is positioned in the active area for displaying an image, the second touch electrode 120 is formed of the transparent conductive material.

A plurality of electrode pads 130 are formed on one surface of the substrate 100, for example, the upper surface of the substrate 100. The electrode pads 130 are formed in the peripheral area of the substrate 100 on which an image is not displayed. The plurality of electrode pads 130 are provided in such a manner that the plurality of electrode pads 130 are respectively connected with the plurality of first touch electrodes 110 and the plurality of second touch electrodes 120. In this case, the structure of forming the plurality of electrode pads 130 in any one side among four sides of the rectangular substrate 100 is advantageous because it uses only one FPC film 200.

The electrode pad 130 may include a first electrode pad 131 and second electrode pad(s) 132. The first electrode pad 131 is electrically connected with the first touch electrode 110, and the second electrode pad 132 is electrically connected with the second touch electrode 120.

As mentioned above, the first electrode pad 131 and the second electrode pad 132 may be formed in any one of the four sides of the substrate 100. Preferably, the first electrode pad 131 is formed in the center of any one side of the substrate 100, and the second electrode pad 132 is formed adjacent to the end of any one side of the substrate 100, that is, corner of the substrate 100. This arrangement allows both easy electrical connection between the first electrode pad 131 and the first touch electrode 110 and easy electrical connection between the second electrode pad 132 and the second touch electrode 120.

As mentioned above, the electrode pad 130 is formed in the peripheral area of the substrate 100 on which an image is not displayed. It is unnecessary that the electrode pad 130 be formed of the transparent conductive material with relatively low conductivity. Preferably, the electrode pad 130 is formed of a metal material with high conductivity.

The connection line 140 may include a first connection line 141 and a second connection line 142.

The first connection line 141 is formed on one surface of the substrate 100, for example, a peripheral area on the upper surface of the substrate 100. The second connection line 142 is formed on the other surface of the substrate 100, for example, a peripheral area on the lower surface of the substrate 100.

The first connection line 141 electrically connects the first electrode pad 131 and the first touch electrode 110 with each other. That is, one end 141a of the first connection line 141 is connected with the first touch electrode 110, and the other end of the first connection line 141 is connected with the first electrode pad 131.

The first connection line 141, the first electrode pad 131, and the first touch electrode 110 are formed on one surface of the substrate 100, whereby the above first connection line 141, the first electrode pad 131, and the first touch electrode 110 may be directly connected with one another. Especially, the first connection line 141 and the first electrode pad 131 may be formed as one body on one surface of the substrate 100.

A width of one end 141a of the first connection line 141 is relatively larger than a width of the remaining portions of the first connection line 141, which enables an easy electrical connection between the first touch electrode 110 and the first connection line 141. Thus, the width of the first connection line 141 is not consistent along the length of the first connection line 141.

The second connection line 142 electrically connects the second electrode pad 132 and the second touch electrode 120 with each other. That is, one end 142a of the second connection line 142 is connected with the second touch electrode 120, and the other end 142b of the second connection line 142 is connected with the second electrode pad 132.

The second connection line 142 and the second touch electrode 120 are formed on the other surface of the substrate 100, whereby the second connection line 142 and the second touch electrode 120 may be directly connected with each other. However, since the second connection line 142 and the second electrode pad 132 are formed on the different surfaces of the substrate 100, an additional structure is needed to connect the second connection line 142 and the second electrode pad 132 with each other. That is, as shown in an expanded view of FIG. 3, a contact hole CH is formed in a predetermined region of the substrate 100, and more particularly, a region where the other end 142b of the second connection line 142 overlaps with the second electrode pad 132, and a contact electrode 150 is formed inside the contact hole CH. Accordingly, the second connection line 142 and the second electrode pad 132 are electrically connected with each other by the contact electrode 150.

A width of each end 142a and end 142b in the second connection line 142 is relatively larger than a width of the remaining portions of the second connection line 142, which enables an easy electrical connection between one end 142a of the second connection line 142 and the second touch electrode 120, and an easy electrical connection between the other end 142b of the second connection line 142 and the second electrode pad 132. Thus, the width of the second connection line 142 is not consistent along the length of the second connection line 142.

Hereinafter, the touch panel 1 according to various embodiments will be described with the following cross sectional views.

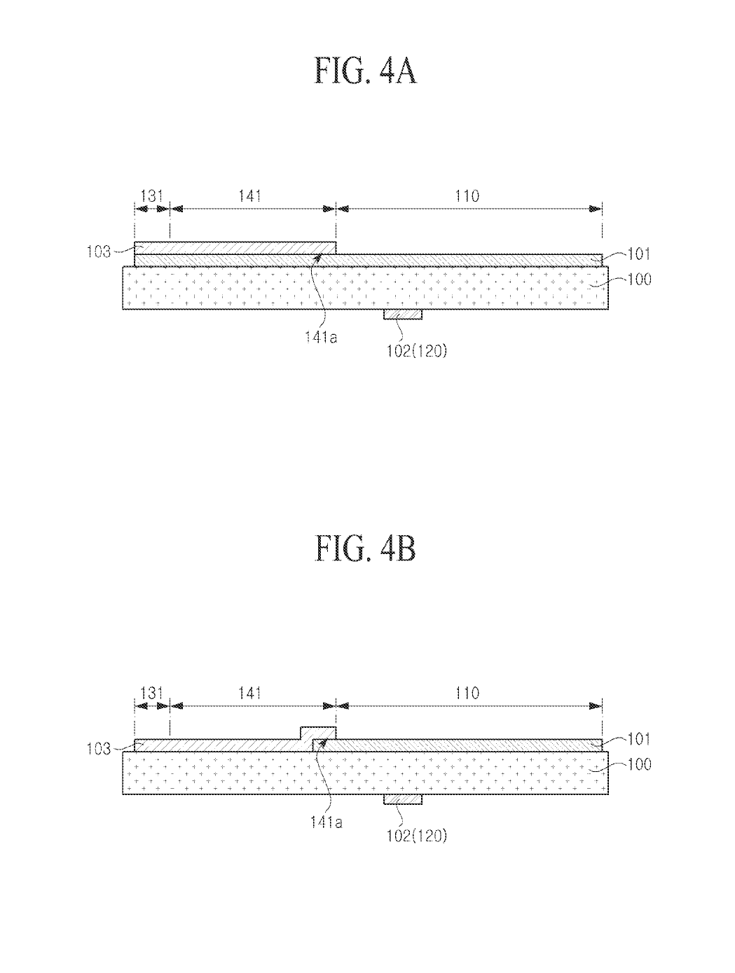

FIGS. 4A and 4B are cross sectional views along A-A of FIG. 3 illustrating touch panels according to various embodiments of the present invention.

FIG. 4A is a cross sectional view illustrating the touch panel 1 according to one embodiment. As shown in FIG. 4A, a first touch electrode 110, a first connection line 141, and a first electrode pad 131 are sequentially formed on one surface of a substrate 100.

The first touch electrode 110 comprises a first transparent conductive layer 101. Each of the first connection line 141 and the first electrode pad 131 comprises a first transparent conductive layer 101 and a first metal layer 103 deposited in sequence.

Both the first transparent conductive layer 101 constituting the first touch electrode 110 and the first transparent conductive layer 101 constituting the first connection line 141 and the first electrode pad 131 are simultaneously formed of the same material, and are connected with each other while being as one body.

The first connection line 141 and the first electrode pad 131 are also formed of the same material, and are connected with each other while being as one body.

A second touch electrode 120 is formed on the other surface of the substrate 100. The second touch electrode 120 comprises a second transparent conductive layer 102.

FIG. 4B is a cross sectional view illustrating the touch panel 1 according to another embodiment of the present invention. Except that a first electrode pad 131 and a first connection line 141 are changed in structure, the touch panel 1 of FIG. 4B is identical in structure to the touch panel of FIG. 4A, whereby only different structures will be described.

As shown in FIG. 4B, a first electrode pad 131 comprises a first metal layer 103. Also, one end 141a of a first connection line 141 comprises a first transparent conductive layer 101 and a first metal layer 103 deposited in sequence, but the remaining portions of the first connection line 141 comprise only the first metal layer 103.

Both the first metal layer 103 constituting the first connection line 141 and the first metal layer 103 constituting the first electrode pad 131 are simultaneously formed of the same material, and are connected with each other while being as one body. In the embodiment of FIG. 4B, the first metal layer 103 has better adhesion to the substrate 100 compared to the embodiment of FIG. 4A since the first metal layer 103 is formed directly on the substrate 100.

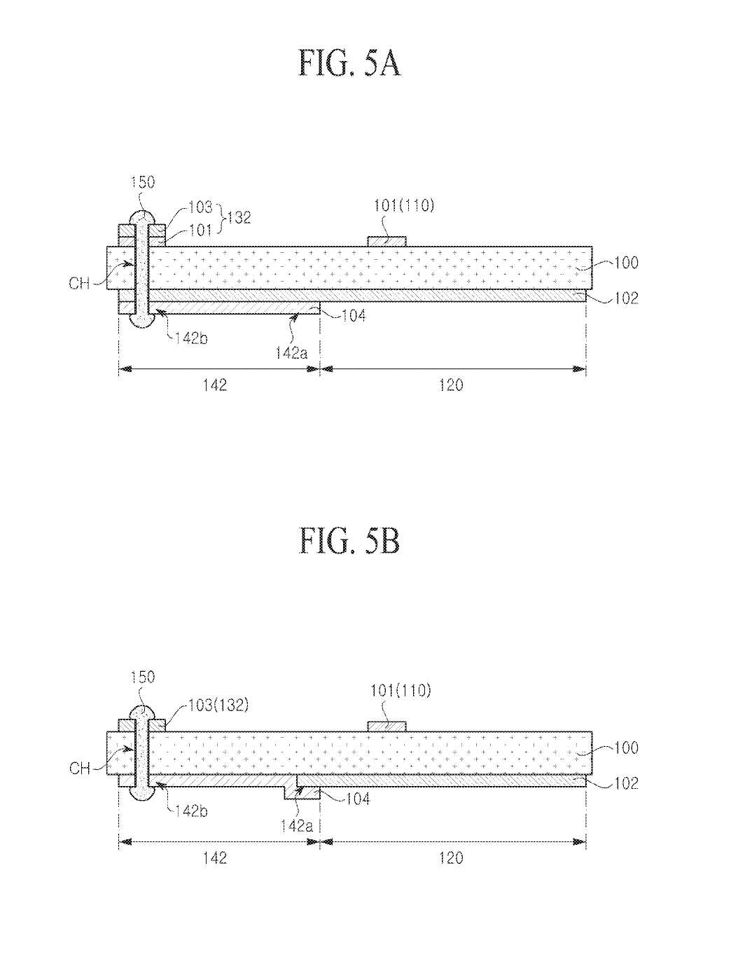

FIGS. 5A and 5B are cross sectional views along B-B of FIG. 3 illustrating the touch panel 1 according to various embodiments of the present invention.

FIG. 5A is a cross sectional view illustrating the touch panel 1 according to one embodiment of the present invention. As shown in FIG. 5A, a first touch electrode 110 and a second electrode pad 132 are formed on one surface of a substrate 100.

The first touch electrode 110 comprises a first transparent conductive layer 101, and the second electrode pad 132 comprises a first transparent conductive layer 101 and a first metal layer 103 deposited in sequence.

A second touch electrode 120 and a second connection line 142 are formed on the other surface of the substrate 100.

The second touch electrode 120 comprises a second transparent conductive layer 102. The second connection line 142 comprises the second transparent conductive layer 102 and a second metal layer 104 deposited in sequence. Both the second transparent conductive layer 102 constituting the second touch electrode 120 and the second transparent conductive layer 102 constituting the second connection line 142 are simultaneously formed of the same material, and are connected with each other while being as one body.

A second electrode pad 132 formed on one surface of the substrate 100 is electrically connected with the other end 142b of the second connection line 142 formed on the other surface of the substrate 100 through the use of contact electrode 150. In more detail, a contact hole CH passing through the second electrode pad 132, the other end 142b of the second connection line 142 and the substrate 100 is formed, and the contact electrode 150 is formed inside the contact hole CH. Accordingly, as the contact electrode 150 is formed inside the contact hole CH, the contact electrode 150 is connected with the second electrode pad 132 and the other end 142b of the second connection line 142. The contact electrode 150 may protrude above the second electrode pad 132, and also may protrude below the other end 142b of the second connection line 142, but not necessarily.

FIG. 5B is a cross sectional view illustrating the touch panel 1 according to another embodiment of the present invention. Except that a second electrode pad 132 and a second connection line 142 are changed in structure, the touch panel 1 of FIG. 5B is identical in structure to the touch panel of FIG. 5A, whereby only different structures will be described.

As shown in FIG. 5B, a second electrode pad 132 comprises a first metal layer 103. Also, one end 142a of a second connection line 142 comprises a second transparent conductive layer 102 and a second metal layer 104 deposited in sequence, but the remaining portions of the second connection line 142 including the other end 142b comprise only the second metal layer 104. In the embodiment of FIG. 5B, the second metal layer 104 and the first metal layer 103 have better adhesion to the substrate 100 compared to the embodiment of FIG. 5A since the second metal layer 104 and the first metal layer 103 are formed directly on the substrate 100.

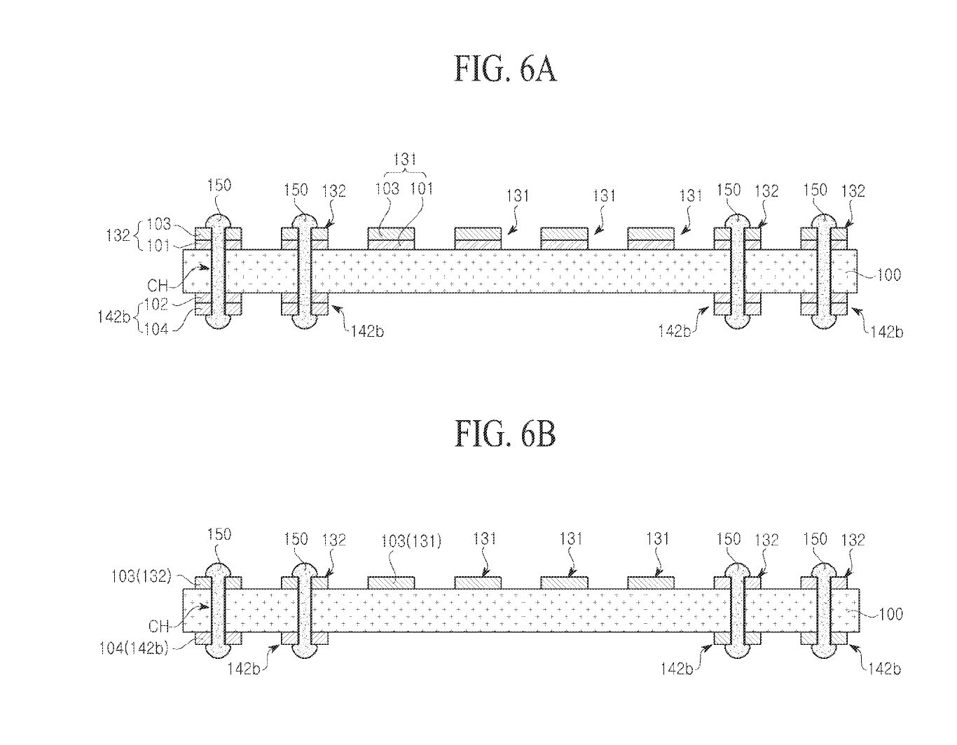

FIGS. 6A and 6B are cross sectional views along C-C of FIG. 3 illustrating the touch panel 1 according to various embodiments of the present invention.

As shown in FIG. 6A, a first electrode pad 131 and a second electrode pad 132 are formed on one surface of a substrate 100.

Each of the first electrode pad 131 and the second electrode pad 132 comprises a first transparent conductive layer 101 and a first metal layer 103 deposited in sequence.

The other end 142b of a second connection line 142 is formed on the other surface of the substrate 100, wherein the other end 142b of the second connection line 142 comprises a second transparent conductive layer 102 and a second metal layer 104 deposited in sequence.

The second electrode pad 132 formed on one surface of the substrate 100 is electrically connected with the other end 142b of the second connection line 142 formed on the other surface of the substrate 100 by a contact electrode 150 formed inside a contact hole CH.

FIG. 6B is a cross sectional view illustrating the touch panel 1 according to another embodiment of the present invention. In FIG. 6B, each of a first electrode pad 131 and a second electrode pad 132 comprises a first metal layer 103, and the other end 142b of a second connection line 142 comprises only a second metal layer 104.

Although not shown, each of the first electrode pad 131 and the second electrode pad 132 may comprise a first transparent conductive layer 101 and a first metal layer 103 deposited in sequence, and the other end 142b of the second connection line 142 may comprise only the second metal layer 104. On the contrary, each of the first electrode pad 131 and the second electrode pad 132 may comprise only the first metal layer 103, and the other end 142b of the second connection line 142 may comprise a second transparent conductive layer 102 and the second metal layer 104 deposited in sequence. In the embodiment of FIG. 6B, the first metal layer 103 and the second metal layer 104 have better adhesion to the substrate 100 compared to the embodiment of FIG. 6A since the first metal layer 103 and the second metal layer 104 are formed directly on the substrate 100.

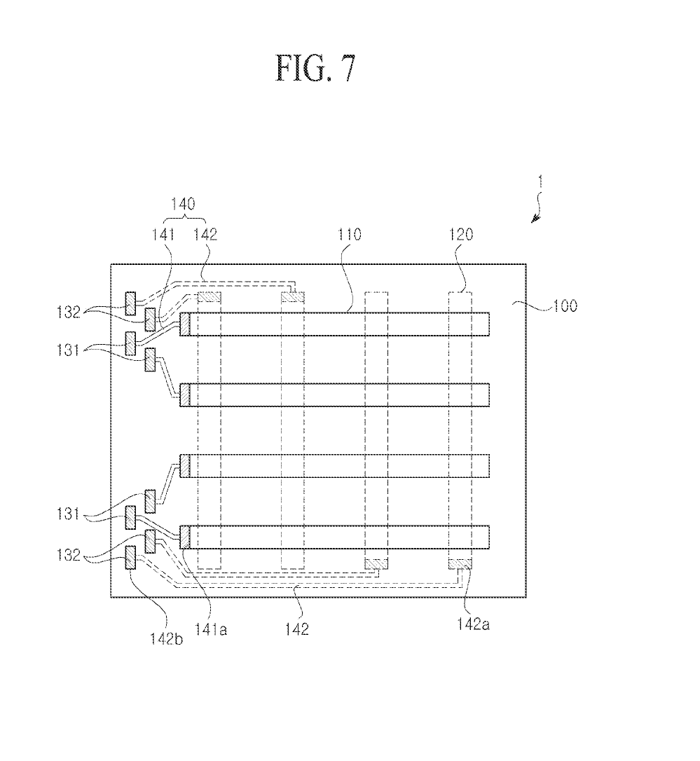

FIG. 7 is a plane view illustrating the touch panel 1 according to another embodiment of the present invention.

Except that an arrangement of electrode pads 130 is changed, the touch panel 1 of FIG. 7 is identical in structure to the touch panel of FIG. 3, whereby only different structures will be described.

According to the aforementioned touch panel of FIG. 3, the plurality of electrode pads 130, wherein each electrode pad 130 comprises the first electrode pad 131 and the second electrode pad 132, are arranged in one column on the peripheral area of one surface of the substrate 100. On the other hand, according to the touch panel of FIG. 7, a plurality of electrode pads 130, wherein each electrode pad 130 comprises a first electrode pad 131 and a second electrode pad 132, may be arranged in two columns on a peripheral area of one surface of a substrate 100. In case of the arrangement of the electrode pads 130 shown in FIG. 7, there may be provided more spaces in the peripheral area on one surface of the substrate 100, that is, other elements may be additionally provided in the spaces.

FIG. 7 illustrates that the electrode pads 130 are arranged in two columns on the peripheral area of one surface of the substrate 100, but not necessarily. The plurality of electrode pads 130 may be arranged in three or more columns.

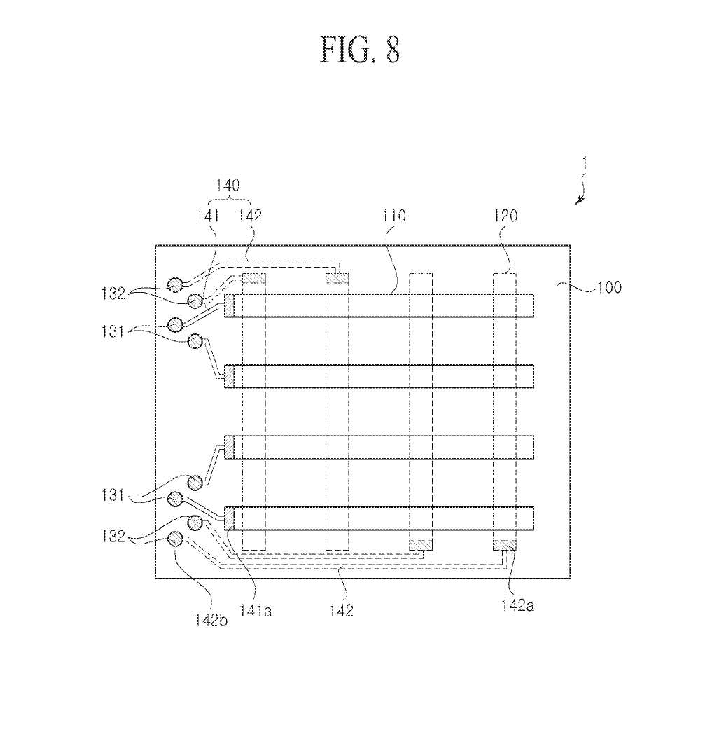

FIG. 8 is a plane view illustrating the touch panel 1 according to another embodiment of the present invention. Except that an electrode pad 130 is changed in shape, the touch panel of FIG. 8 is identical in structure to the touch panel of FIG. 7.

According to the touch panel of FIG. 7, each of the first electrode pad 131 and the second electrode pad 132 has a square-shaped cross section. On the other hand, according to the touch panel of FIG. 8, each of first electrode pad 131 and second electrode pad 132 has a circle-shaped cross section.

If each of the first electrode pad 131 and second electrode pad 132 has the circle-shaped cross section, it enables the generation of more space in a peripheral area on one surface of a substrate 100, with high efficiency. Using first electrode pads 131 and second electrode pads 132 with the circle-shaped cross section saves space on the surface of the substrate 100 compared to the embodiment of the electrode pads with the square-shaped cross section.

Although not shown, the cross section in each of the first electrode pad 131 and second electrode pad 132 may be changed in various shapes, for example, elliptical shape or hexagonal shape.

Also, the shape of first electrode pad 131 may be different from the shape of second electrode pad 132.

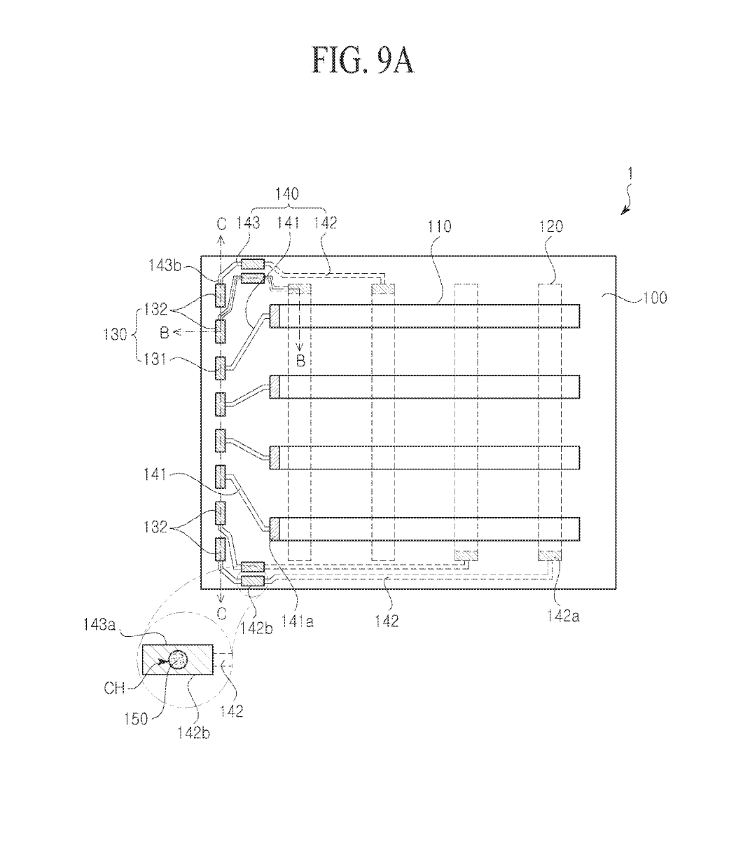

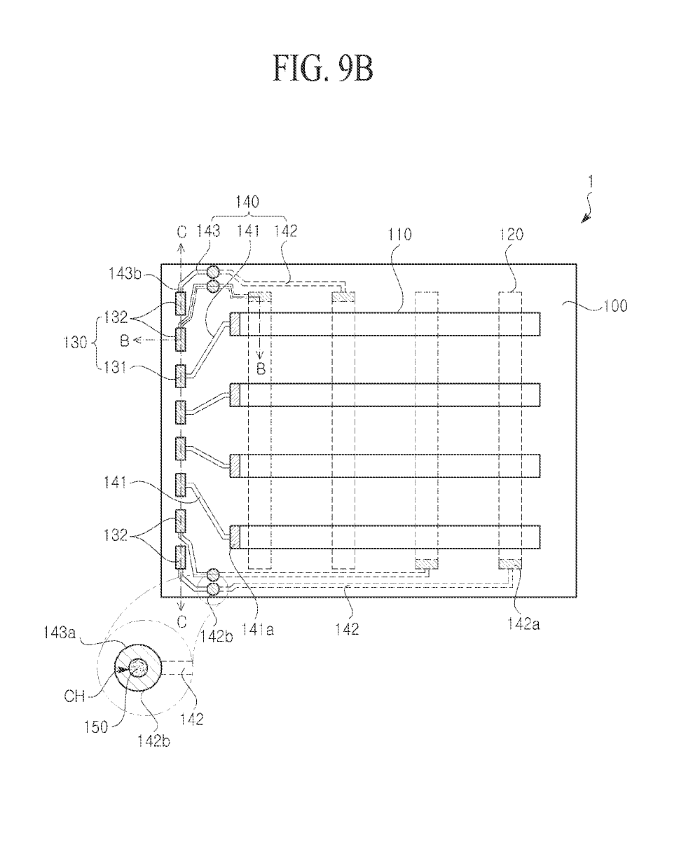

FIG. 9A is a plane view illustrating the touch panel 1 according to another embodiment of the present invention. Except an electrical connection method between a second touch electrode 120 and a second electrode pad 132, the touch panel of FIG. 9A is identical in structure to the touch panel 1 of FIG. 3, whereby a detailed explanation for the same parts will be omitted.

As shown in FIG. 9A, the touch panel 1 according to another embodiment of the present invention may include a substrate 100, a first touch electrode 110, a second touch electrode 120, an electrode pad 130, a connection line 140, and a contact electrode 150.

The first touch electrode 110 is formed on one surface of the substrate 100, and the second touch electrode 120 is formed on the other surface of the substrate 100.

The electrode pad 130 comprises a first electrode pad 131 and a second electrode pad 132 formed in a peripheral area of one surface of the substrate 100. The first electrode pad 131 is electrically connected with the first touch electrode 110, and the second electrode pad 132 is electrically connected with the second touch electrode 120.

The connection line 140 may comprise a first connection line 141, a second connection line 142, and a third connection line 143.

The first connection line 141 is formed in the peripheral area on one surface of the substrate 100, the second connection line 142 is formed in the peripheral area on the other surface of the substrate 100, and the third connection line 143 is formed in the peripheral area on one surface of the substrate 100.

The first connection line 141 electrically connects the first electrode pad 131 and the first touch electrode 110 with each other.

The second connection line 142 and the third connection line 143 electrically connect the second electrode pad 132 and the second touch electrode 120 with each other. In more detail, one end 142a of the second connection line 142 is connected with the second touch electrode 120, the other end 142b of the second connection line 142 is connected with one end 143a of the third connection line 143, and the other end 143b of the third connection line 143 is connected with the second electrode pad 132.

One end 142a of the second connection line 142 is directly connected with the second touch electrode 120, and the other end 143b of the third connection line 143 is directly connected with the second electrode pad 132. However, since the other end 142b of the second connection line 142 and one end 143a of the third connection line 143 are formed on the different surfaces of the substrate 100, an additional structure is needed to electrically connect the other end 142b of the second connection line 142 and one end 143a of the third connection line 143 with each other.

That is, as shown in an expanded view of FIG. 9A, a contact hole CH is formed in a predetermined region of the substrate 100, and more particularly, a region where the other end 142b of the second connection line 142 overlaps with one end 143a of the third connection line 143, and the contact electrode 150 is formed inside the contact hole CH. Accordingly, the second connection line 142 and the third connection line 143 are electrically connected with each other by the contact electrode 150.

In case of the touch panel 1 shown in FIG. 9A, since the contact electrode 150 is not in contact with the second electrode pad 132, a process of attaching the FPC film (See ‘200’ of FIG. 2) to the second electrode pad 132 may be carried out with easiness. That is, if the contact electrode 150 protrudes out of the second electrode pad 132, a step difference may occur between the second electrode pad 132 and the first electrode pad 131. In this case, a process of attaching the FPC film to the first electrode pad 131 and the second electrode pad 132 may be difficult.

Hereinafter, a cross sectional structure of the touch panel 1 of FIG. 9A will be described in detail as follows.

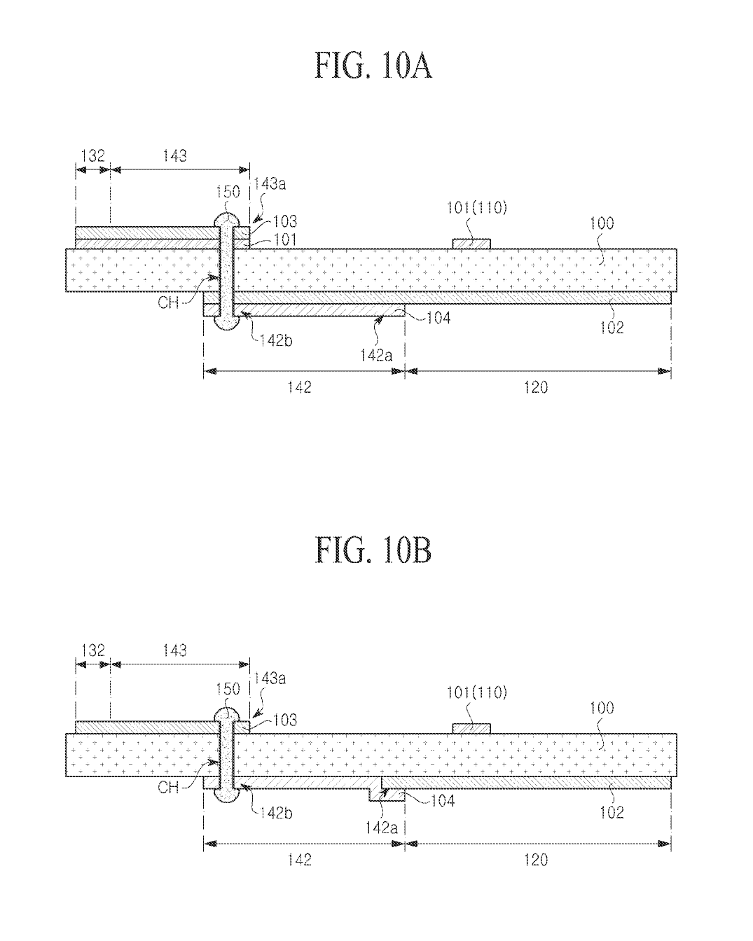

FIGS. 10A and 10B are cross sectional views along B-B of FIG. 9A illustrating various embodiments.

As shown in FIG. 10A, a first touch electrode 110, a third connection line 143, and a second electrode pad 132 are formed on one surface of a substrate 100.

The first touch electrode 110 comprises a first transparent conductive layer 101. Each of the third connection lines 143 and the second electrode pad 132 comprises a first transparent conductive layer 101 and a first metal layer 103 deposited in sequence. The third connection line 143 and the second electrode pad 132 are formed as one body.

On the other surface of the substrate 100, there are a second touch electrode 120 and a second connection line 142. The second touch electrode 120 comprises a second transparent conductive layer 102. The second connection line 142 comprises a second transparent conductive layer 102 and a second metal layer 104 deposited in sequence.

One end 143a of the third connection line 143 formed on one surface of the substrate 100 is electrically connected with the other end 142b of the second connection line 142 formed on the other surface of the substrate 100 by a contact electrode 150. In more detail, a contact hole CH passing through one end 143a of the third connection line 143, the other end 142b of the second connection line 142 and the substrate 100 is formed, and the contact electrode 150 is formed inside the contact hole CH.

Except structures of third connection line 143, second electrode pad 132 and second connection line 142, the touch panel of FIG. 10B is identical in structure to the touch panel of FIG. 10A, whereby only different structures will be described.

As shown in FIG. 10B, each of third connection line 143 and second electrode pad 132 comprises a first metal layer 103. Also, one end 142a of second connection line 142 comprises a second transparent conductive layer 102 and a second metal layer 104 deposited in sequence, and the remaining portions of the second connection line 142 including the other end 142b comprise only the second metal layer 104. In the embodiment of FIG. 10B, the first metal layer 103 and the second metal layer 104 have better adhesion to the substrate 100 compared to the embodiment of FIG. 10A since the first metal layer 103 and the second metal layer 104 are formed directly on the substrate 100.

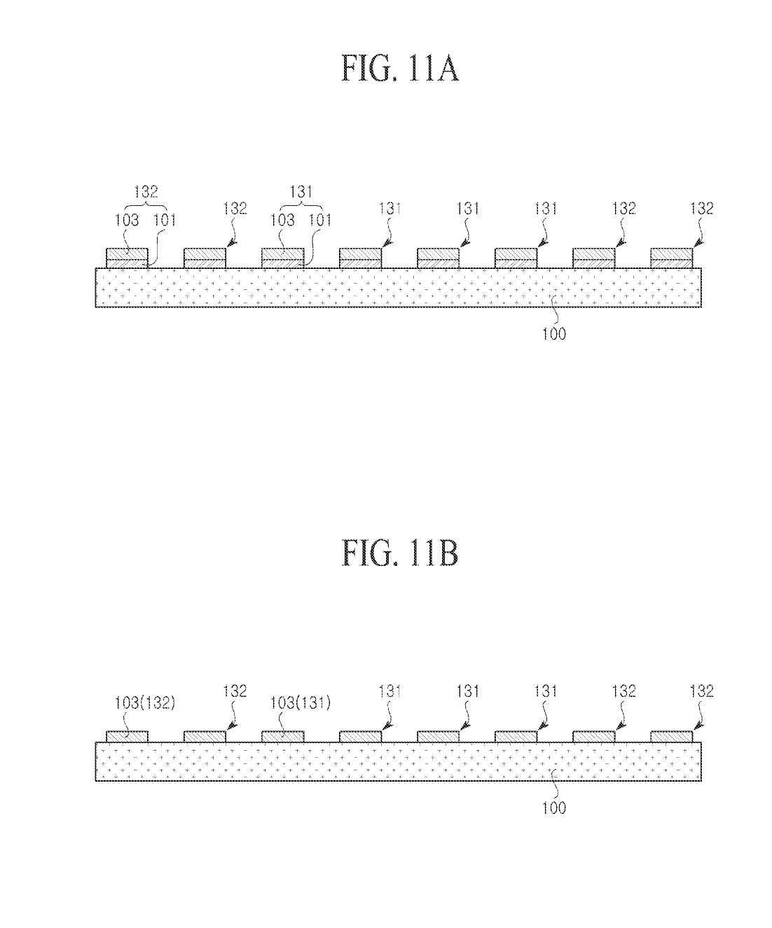

FIGS. 11A and 11B are cross sectional views along C-C of FIG. 9A illustrating various embodiments.

As shown in FIGS. 11A and 11B, a first electrode pad 131 and a second electrode pad 132 are formed on one surface of a substrate 100.

Each of the first electrode pad 131 and the second electrode pad 132 may comprise a first transparent conductive layer 101 and a first metal layer 103 deposited in sequence, as shown in FIG. 11, or may comprise only the first metal layer 103, as shown in FIG. 11B. In the embodiment of FIG. 11B, the first metal layer 103 has better adhesion to the substrate 100 compared to the embodiment of FIG. 11A since the first metal layer 103 is formed directly on the substrate 100.

FIG. 9B is a plane view illustrating the touch panel 1 according to another embodiment of the present invention. Except the shape in one end 143a of third connection line 143 and the other end 142b of second connection line 142 formed in a region of contact electrode 150, the touch panel 1 of FIG. 9B is identical in structure to the touch panel 1 of FIG. 9A, whereby a detailed explanation for the same parts will be omitted.

In case of FIG. 9A, the contact electrode 150 has the circle-shaped cross section, and the other end 142b of the second connection line 142 and one end 143a of the third connection line 143 have the square-shaped cross section.

On the other hand, as shown in FIG. 9B, a contact electrode 150 has a circle-shaped cross section, and the other end 142b of second connection line 142 and one end 143a of third connection line 143 have a circle-shaped cross section. If the other end 142b of second connection line 142 and one end 143a of third connection line 143 have the circle-shaped cross section, it enables to generate more spaces in a peripheral area of one surface of a substrate 100, with high efficiency.

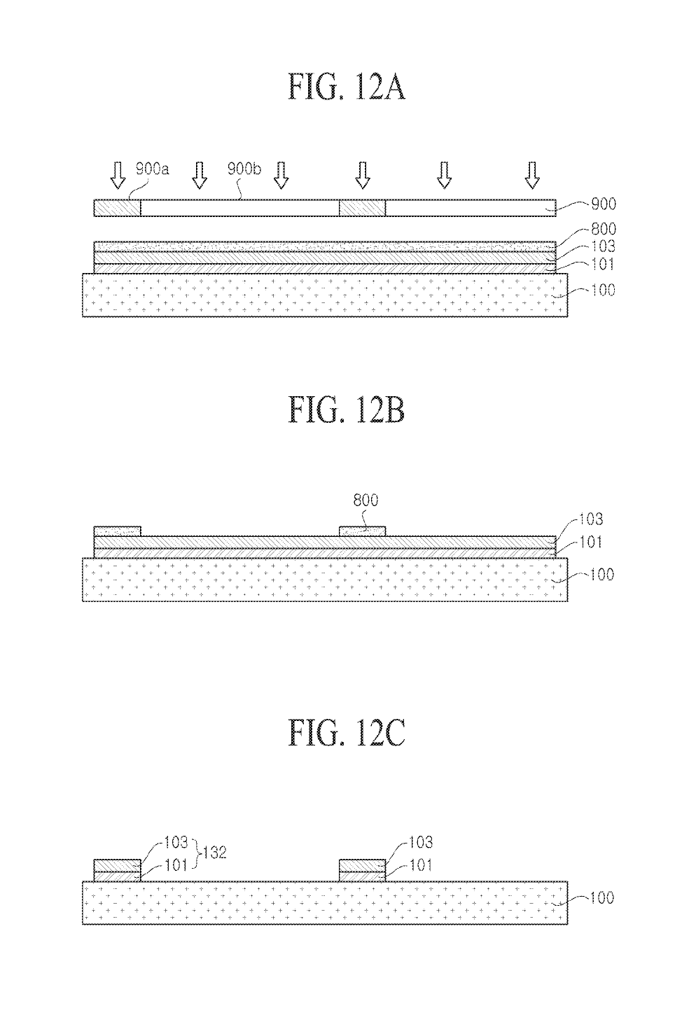

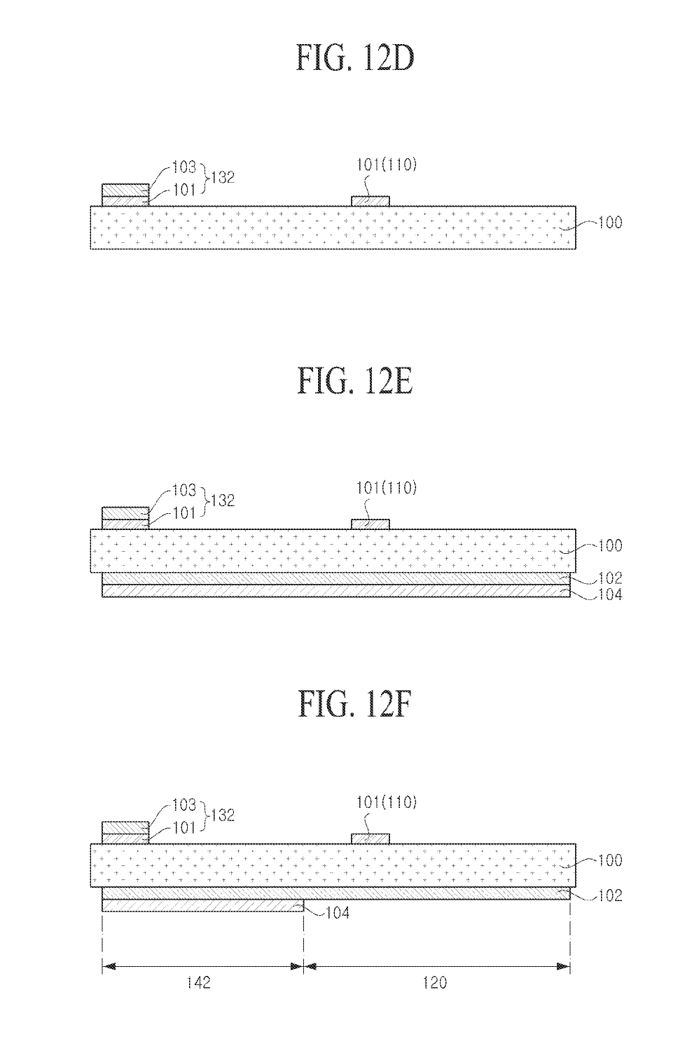

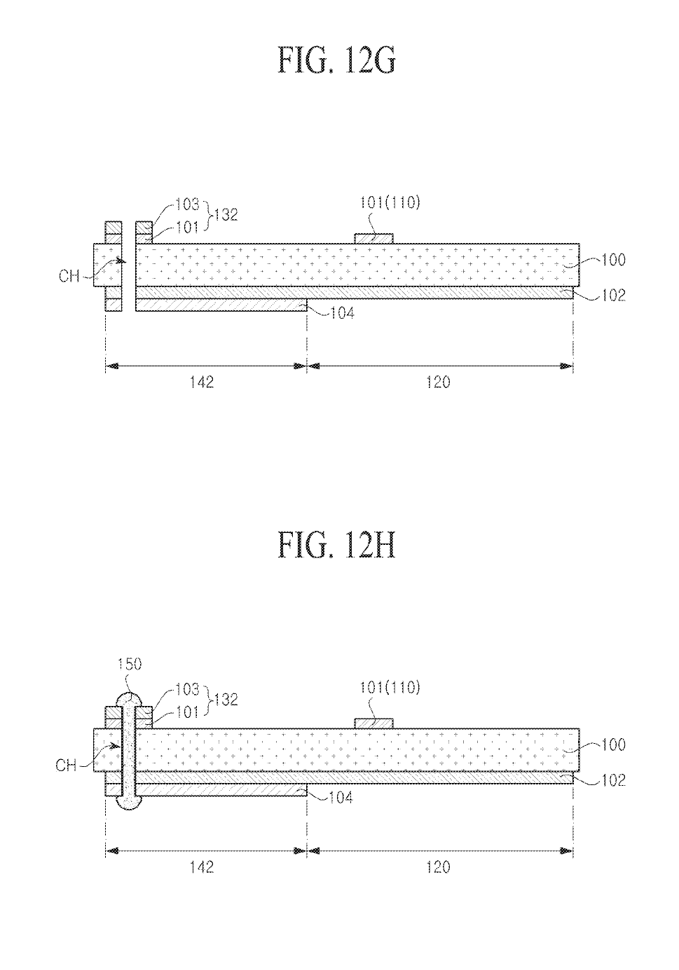

FIGS. 12A to 12H are cross sectional views illustrating a method of manufacturing the touch panel 1 according to one embodiment of the present invention, which relate to the touch panel 1 shown in FIG. 5A.

First, as shown in FIG. 12A, a first transparent conductive layer 101 and a first metal layer 103 are respectively deposited on one surface of a substrate 100, and a photoresist film 800 is formed on the first metal layer 103. Then, light (represented by the arrows in FIG. 12A) is irradiated onto the photoresist film 800 by the use of predetermined mask 900.

The mask 900 comprises a light-shielding part 900a and a light-transmitting part 900b. Thus, only light passing through the light-transmitting part 900b is irradiated onto the photoresist film 800.

As shown in FIG. 12B, a pattern of photoresist film 800 is completed by developing the photoresist film 800 irradiated with light. In the drawings, a region irradiated with light is removed by development. However, a region which is not irradiated with light may be removed according to the property of photoresist film 800.

Then, as shown in FIG. 12C, under the condition that the pattern of photoresist film 800 is used as the mask, the first transparent conductive layer 101 and the first metal layer 103 are etched, and then the pattern of photoresist film 800 is stripped.

Through the above process of etching the first transparent conductive layer 101 and the first metal layer 103, a second electrode pad 132, a first electrode pad (See ‘131’ of FIG. 3), and a first connection line (See ‘141’ of FIG. 3) are formed in a peripheral area on which an image is not displayed. Meanwhile, the first electrode pad 131 and the second electrode pad 132 may be formed in shapes shown in FIG. 7 and FIG. 8 as well as the shape shown in FIG. 3.

As shown in FIGS. 12A to 12C, the photoresist film 800 is irradiated with light by the use of predetermined mask 900, the photoresist film 800 irradiated with light is developed to form the predetermined pattern of photoresist film 800, and the etching process is carried out under the condition that the predetermined pattern of photoresist film 800 is used as the mask. These sequential patterning steps are referred to as a mask process.

Through the mask process, as shown in FIG. 12D, the first metal layer 103 is etched in an active area on which an image is displayed, to thereby pattern a first touch electrode 110.

As shown in FIG. 12E, a second transparent conductive layer 102 and a second metal layer 104 are sequentially deposited on the other surface of the substrate 100.

Through the mask process, as shown in FIG. 12F, a second connection line 142 is patterned in the peripheral area on which an image is not displayed, and then a second touch electrode 120 is patterned in the active area on which an image is displayed.

The second connection line 142 may comprise the second transparent conductive layer 102 and the second metal layer 104 deposited in sequence. The second touch electrode 120 may comprise the second transparent conductive layer 102.

As shown in FIG. 12G, a contact hole CH is formed in a predetermined region of the second electrode pad 132, the second connection line 142, and the substrate 100.

Then, as shown in FIG. 12H, a contact electrode 150 is formed inside the contact hole CH, to thereby electrically connect the second electrode pad 132 and the second connection line 142 with each other. The contact electrode 150 may be formed of a metal paste such as argentum (Ag).

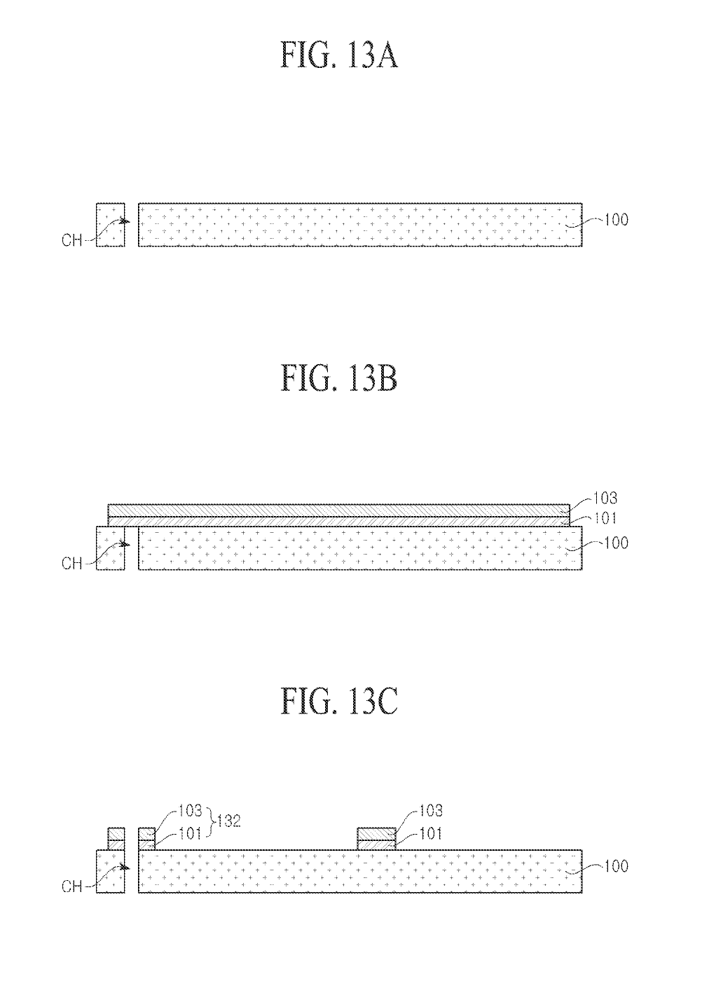

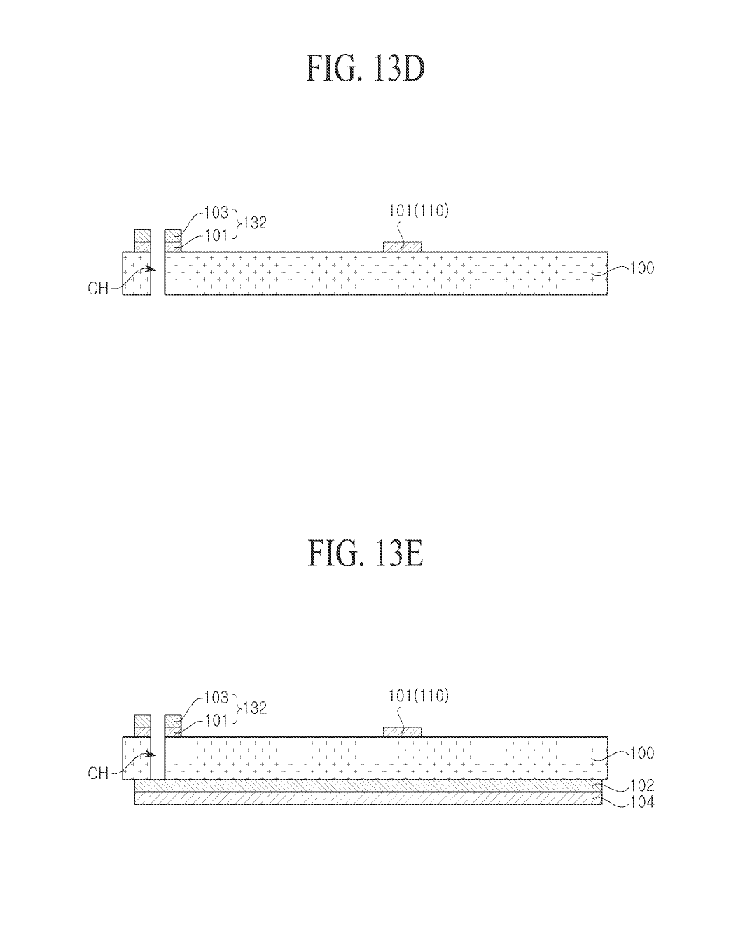

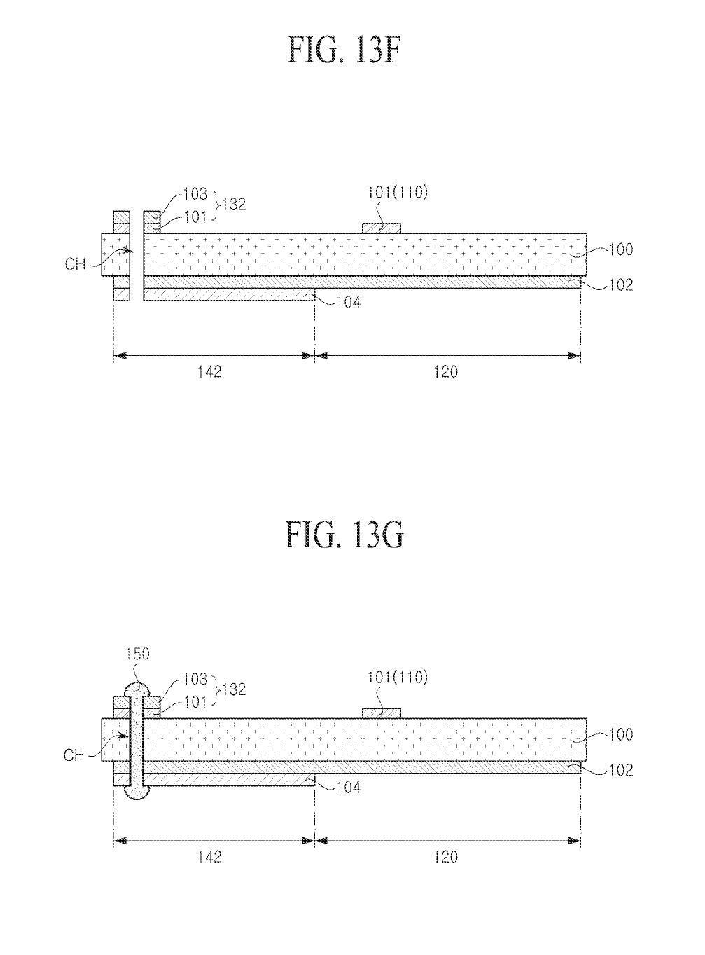

FIGS. 13A to 13G are cross sectional views illustrating a method of manufacturing the touch panel 1 according to another embodiment of the present invention, which relate to the touch panel 1 shown in FIG. 5A.

First, as shown in FIG. 13A, a contact hole CH is formed in a substrate 100. The contact hole CH is formed in a peripheral area on which an image is not displayed.

Then, as shown in FIG. 13B, a first transparent conductive layer 101 and a first metal layer 103 are sequentially deposited on one surface of the substrate 100.

Through a mask process, as shown in FIG. 13C, a second electrode pad 132, a first electrode pad (See ‘131’ of FIG. 3), and a first connection line (See ‘141’ of FIG. 3) are patterned in the peripheral area on which an image is not displayed. In this case, the second electrode pad 132 is patterned to include the contact hole CH.

Through the mask process, as shown in FIG. 13D, a first touch electrode 110 is patterned by etching the first metal layer 103 of an active area on which an image is displayed.

As shown in FIG. 13E, a second transparent conductive layer 102 and a second metal layer 104 are sequentially deposited on the other surface of the substrate 100.

Through the mask process, as shown in FIG. 13F, a second connection line 142 is patterned in the peripheral area on which an image is not displayed, and then a second touch electrode 120 is patterned in the active area on which an image is displayed. In this case, the second connection line 142 is patterned to include the contact hole CH.

As shown in FIG. 13G, a contact electrode 150 is formed inside the contact hole CH, to thereby electrically connect the second electrode pad 132 and the second connection line 142 with each other.

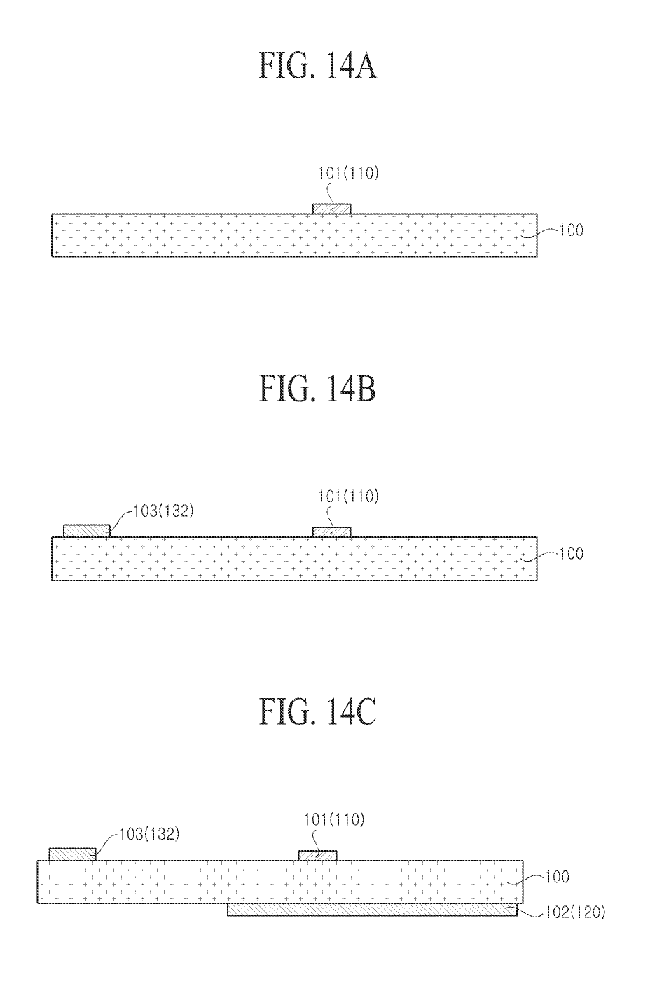

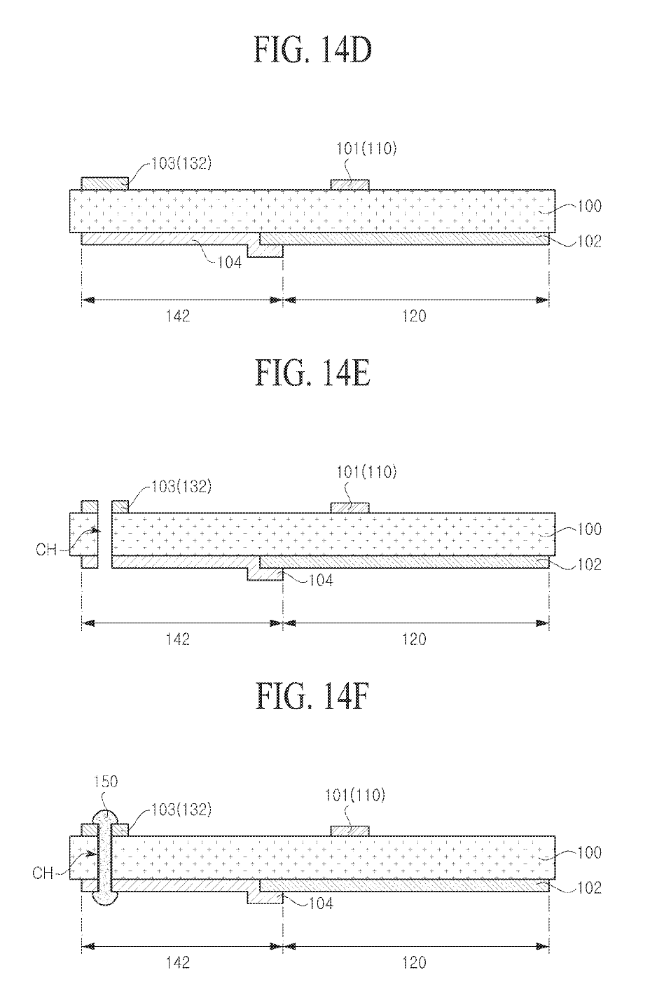

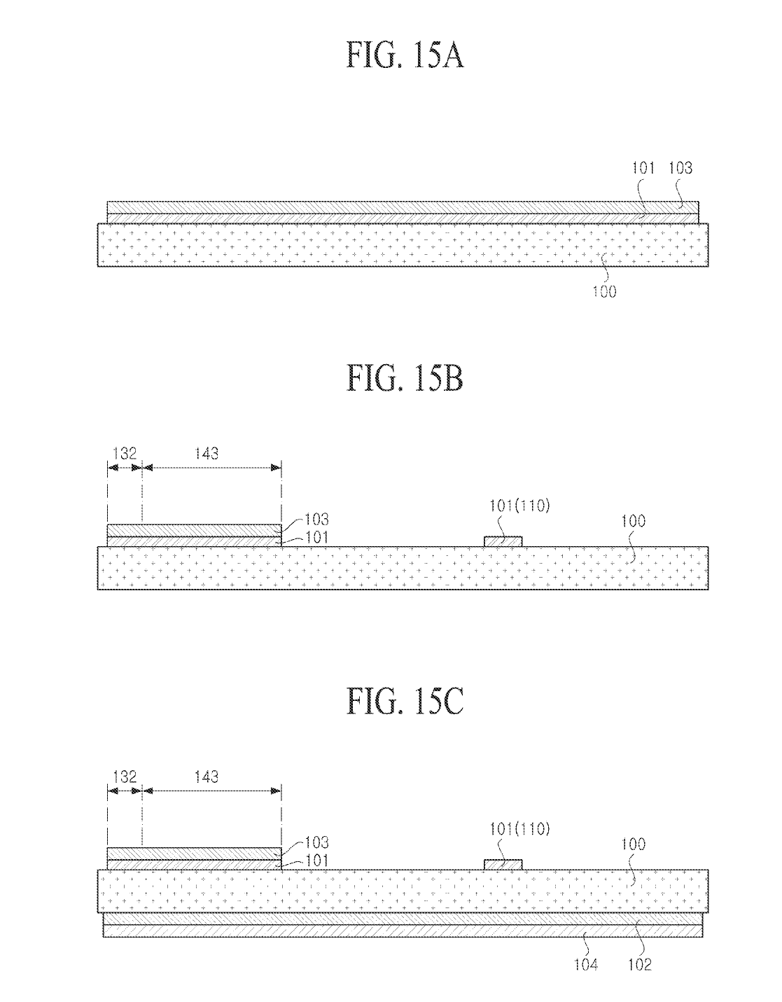

FIGS. 14A to 14F are cross sectional views illustrating a method of manufacturing the touch panel 1 according to another embodiment of the present invention, which relate to the touch panel 1 shown in FIG. 5B.

First as shown in FIG. 14A, a first transparent conductive layer 101 is deposited on one surface of a substrate 100, and a first touch electrode 110 is patterned in an active area on which an image is displayed, through a mask process.

Then, as shown in FIG. 14B, a first metal layer 103 is deposited on one surface of the substrate 100, and then a second electrode pad 132, a first electrode pad (See ‘131’ of FIG. 3) and a first connection line (See ‘141’ of FIG. 3) are patterned in a peripheral area on which an image is not displayed, through the mask process.

As shown in FIG. 14C, a second transparent conductive layer 102 is deposited on the other surface of the substrate 100, and then a second touch electrode 120 is patterned in the active area on which an image is displayed, through the mask process.

As shown in FIG. 14D, a second metal layer 104 is deposited on the other surface of the substrate 100, and then a second connection line 142 is patterned in the peripheral area on which an image is not displayed, through the mask process.

As shown in FIG. 14E, a contact hole CH is formed in a predetermined region of the second electrode pad 132, the second connection line 142 and the substrate 100.

Then, as shown in FIG. 14F, a contact electrode 150 is formed inside the contact hole CH, to thereby electrically connect the second electrode pad 132 and the second connection line 142 with each other.

Although not shown, it is possible to manufacture the touch panel of FIG. 5B by carrying out the mask process after forming the contact hole CH in the substrate 100.

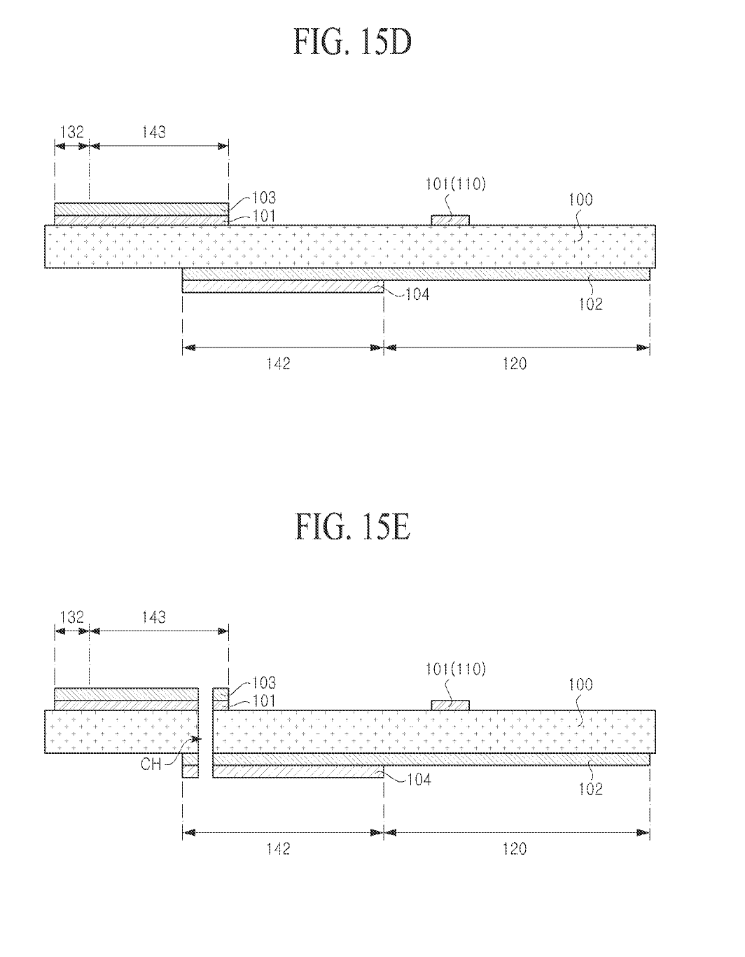

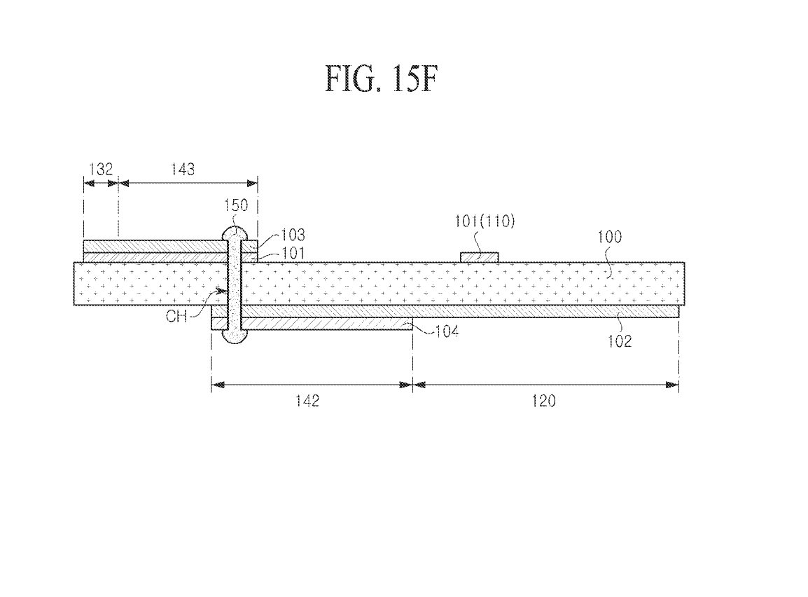

FIGS. 15A to 15F are cross sectional views illustrating a method of manufacturing the touch panel 1 according to another embodiment of the present invention, which relate to the touch panel 1 shown in FIG. 10A.

First, as shown in FIG. 15A, a first transparent conductive layer 101 and a first metal layer 103 are sequentially deposited on one surface of a substrate 100.

Then, as shown in FIG. 15B, a second electrode pad 132, a third connection line 143, a first electrode pad (See ‘131’ of FIG. 3) and a first connection line (See ‘141’ of FIG. 3) are patterned in a peripheral area on which an image is not displayed, through a mask process. Then, a first touch electrode 110 is patterned by etching the first metal layer 103 of an active area on which an image is displayed.

As shown in FIG. 15C, a second transparent conductive layer 102 and a second metal layer 104 are sequentially deposited on the other surface of the substrate 100.

Through the mask process, as shown in FIG. 15D, a second connection line 142 is patterned in the peripheral area on which an image is displayed, and then a second touch electrode 120 is patterned by etching the second metal layer 104 of the active area on which an image is displayed.

Then, as shown in FIG. 15E, a contact hole CH is formed in a predetermined region of the third connection line 143, the second connection line 142 and the substrate 100.

As shown in FIG. 15F, a contact electrode 150 is formed inside the contact hole CH, to thereby electrically connect the third connection line 143 and the second connection line 142 with each other.

Although not shown, it is possible to manufacture the touch panel of FIG. 10A by carrying out the mask process after forming the contact hole CH in the substrate 100.

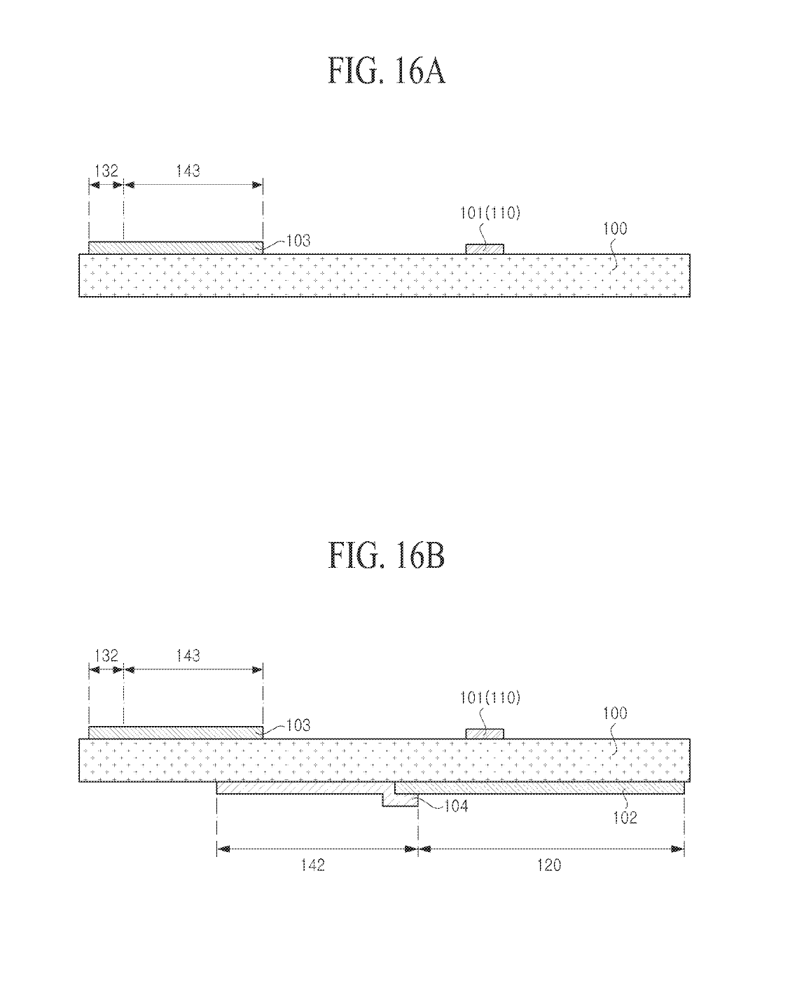

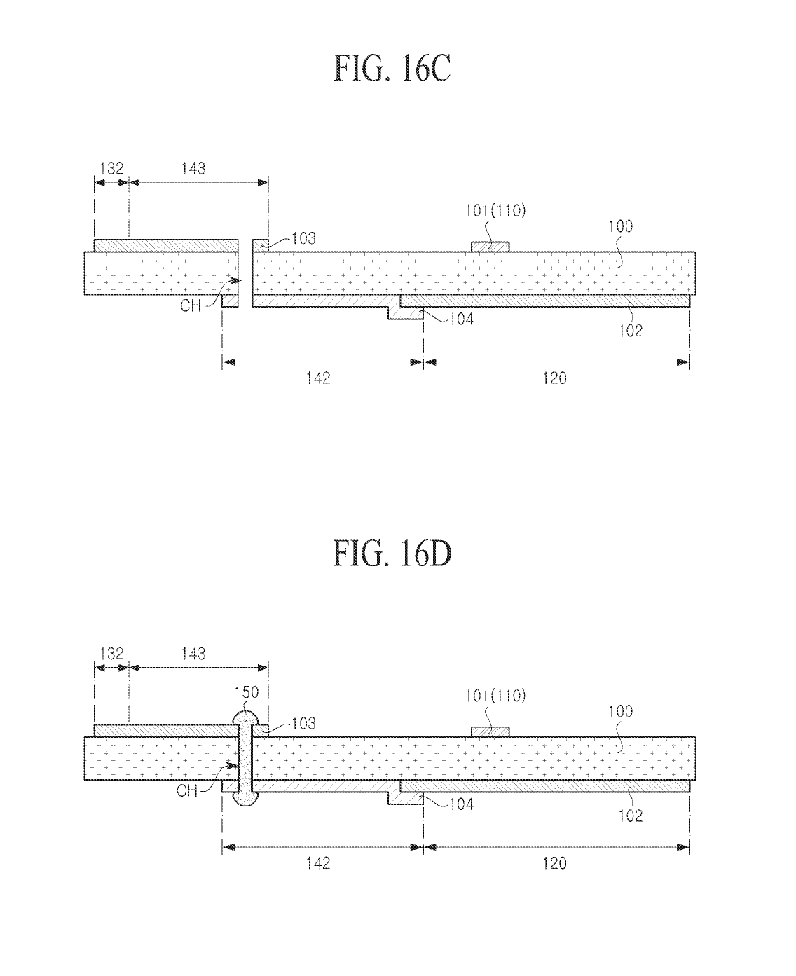

FIGS. 16A to 16D are cross sectional views illustrating a method of manufacturing the touch panel 1 according to another embodiment of the present invention, which relate to the touch panel 1 shown in FIG. 10B.

First, as shown in FIG. 16A, a first transparent conductive layer 101 is deposited on one surface of a substrate 100, and then a first touch electrode 110 is patterned in an active area on which an image is displayed, through a mask process. Also, a first metal layer 103 is deposited on one surface of the substrate 100, and then a second electrode pad 132, a third connection line 143, a first electrode pad (See ‘131’ of FIG. 3) and a first connection line (See ‘141’ of FIG. 3) are patterned in a peripheral area on which an image is not displayed, through the mask process.

Then, as shown in FIG. 16B, a second transparent conductive layer 102 is deposited on the other surface of the substrate 100, and then a second touch electrode 120 is patterned in the active area on which an image is displayed, through the mask process. Also, a second metal layer 104 is deposited on the other surface of the substrate 100, and then a second connection line 142 is patterned in the peripheral area on which an image is not displayed, through the mask process.

As shown in FIG. 16C, a contact hole CH is formed in a predetermined region of the third connection line 143, the second connection line 142 and the substrate 100.

As shown in FIG. 16D, a contact electrode 150 is formed inside the contact hole CH, to thereby electrically connect the third connection line 143 and the second connection line 142 with each other.

Although not shown, it is possible to manufacture the touch panel of FIG. 10B by carrying out the mask process after forming the contact hole CH in the substrate 100.

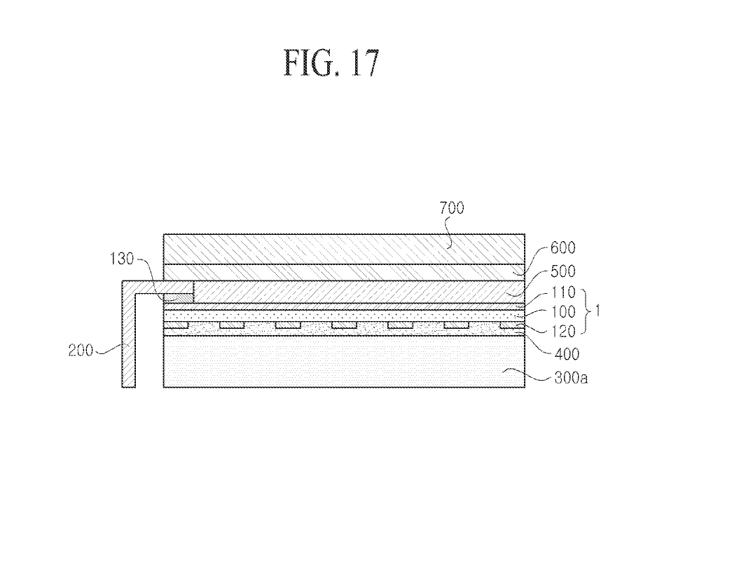

FIG. 17 is a cross sectional view schematically illustrating a display device according to another embodiment of the present invention, and more particularly, organic light emitting display (OLED) device.

As shown in FIG. 17, the OLED device according to one embodiment of the present invention may include a touch panel 1, a flexible printed circuit (FPC) film 200, an organic light emitting display panel 300a, a first adhesive layer 400, a polarizing plate 500, a second adhesive layer 600, and a front substrate 700.

The touch panel 1 may be any one among the above touch panels 1 shown in FIGS. 3 to 11, whereby a detailed explanation for the touch panel 1 will be omitted.

As mentioned above, the FPC film 200 is connected with the touch panel 1 so as to transmit touch signals of the touch panel 1 to a driver (not shown), and a detailed explanation for the FPC film 200 will be omitted.

Although not shown, the organic light emitting display panel 300a may include a switching thin film transistor, a driving thin film transistor, a cathode, an anode, and an organic light emitting layer provided between the cathode and anode. The organic light emitting display panel 300a may be changed to various structures generally known to those in the art.

The first adhesive layer 400 is formed between the touch panel 1 and the organic light emitting display panel 300a, wherein the first adhesive layer 400 attaches the touch panel 1 and the organic light emitting display panel 300a to each other. That is, the first adhesive layer 400 is formed on an upper surface of the organic light emitting display panel 300a, and the touch panel 1 is formed on an upper surface of the first adhesive layer 400. The first adhesive layer 400 may be formed of various materials generally known to those in the art, for example, polymer resin or film type.

The polarizing plate 500 is formed on an upper surface of the touch panel 1. It is possible to omit the polarizing plate 500 if needed.

The second adhesive layer 600 is formed between the polarizing plate 500 and the front substrate 700, wherein the second adhesive layer 600 attaches the polarizing plate 500 and the front substrate 700 to each other. The adhesive layer 600 may be formed of various materials generally known to those in the art, for example, polymer resin or film type.

The front substrate 700 is provided at the front of OLED device, whereby the front substrate 700 may be formed of glass.

Generally, the OLED device may be easily deteriorated by moisture. In case of the related art, a glass for preventing moisture permeation is provided on an upper surface of the organic light emitting display panel 300a.

In case of the present invention, the substrate 100 of the touch panel 1 is formed of a moisture prevention film for preventing moisture permeation, whereby there is no need to additionally provide the glass. Especially, according to the present invention, the FPC film 200 is attached to the upper surface of the touch panel 1, and is not attached to the lower surface of the touch panel 1, which makes it easier to use the touch panel 1 itself as the moisture prevention film.

According to the embodiments of the present invention, the FPC film 200 is formed only one surface of the substrate 100, that is, the FPC film 200 is not formed on the other surface of the substrate 100, to thereby realize the simplified structure of the touch panel 1.

It will be apparent to those skilled in the art that various modifications and variations can be made to embodiments of the present invention without departing from the spirit or scope of the invention. Thus, it is intended that the present invention covers the modifications and variations of this invention provided they come within the scope of the appended claims and their equivalents.

What is claimed is:

1. A touch panel comprising:
a substrate;
a first touch electrode on a first surface of the substrate; and
a second touch electrode on a second surface of the substrate;
wherein the first touch electrode and the second touch electrode are both electrically connected to a same flexible printed circuit film.

2. The touch panel of claim 1, wherein the substrate includes a contact hole and wherein the flexible printed circuit film is connected to the second touch electrode via the contact hole.

3. The touch panel of claim 1, wherein the touch panel further comprises:
a first electrode pad on the first surface of the substrate;
a second electrode pad on the first surface of the substrate;
a contact electrode;
a first connection line on the first surface of the substrate, the first connection line electrically connecting the first touch electrode and the first electrode pad; and
a second connection line on the second surface of the substrate, the second connection line electrically connecting the second touch electrode on the second surface of the substrate and the second electrode pad on the first surface of the substrate via the contact electrode.

4. The touch panel of claim 3, wherein, a first end of the second connection line on the second surface of the substrate is electrically connected to the second touch electrode on the second surface of the substrate, and a second end of the second connection line on the second side of the substrate is electrically connected to the contact electrode, and the contact electrode electrically connects the second end of the second connection line on the second side of the substrate with the second electrode pad on the first surface of the substrate.

5. The touch panel of claim 3, wherein the first electrode pad and the second electrode pad are formed in an area on the first surface of the substrate where an image is not displayed.

6. The touch panel of claim 3, wherein the second electrode pad is formed at any corners of the substrate and the first electrode pad is formed at a position between the corners of the substrate at which the second electrode pad is formed.

7. The touch panel of claim 3, wherein the first touch electrode comprises a first transparent conductive layer deposited on the first surface of the substrate, and one end of the first connection line comprises the first transparent conductive layer and a first metal layer deposited on the first transparent conductive layer.

8. The touch panel of claim 3, wherein a width of one end of the first connection line is larger than a width of the remaining portions of the first connection line.

9. The touch panel of claim 3, wherein a contact hole is formed in a predetermined region including a portion of the substrate, a portion of the second electrode pad, and a portion of the other end of the second connection line, wherein the contact electrode is formed inside the contact hole.

10. The touch panel of claim 3, further comprising a third connection line formed on the first surface of the substrate, wherein one end of the third connection line is electrically connected with the second connection line, and the other end of the third connection line is electrically connected with the second electrode pad,
wherein a contact hole is formed in a predetermined region including a portion of the substrate, a portion of one end of the third connection line, and a portion of the other end of the second connection line, and wherein the contact electrode is formed inside the contact hole.

11. The touch panel of claim 3, wherein the first electrode pads and second electrode pads are arranged in a plurality of columns on the peripheral area of the substrate where an image is not displayed.

12. The touch panel of claim 3, wherein each of the first electrode pad and the second electrode pad has a circle-shaped cross section.

13. The touch panel of claim 10, wherein one end of the third connection line and the other end of the second connection line have a circle-shaped cross section.

14. A method of manufacturing a touch panel comprising:
forming a substrate;
forming a first touch electrode on a first surface of the substrate; and
forming a second touch electrode on a second surface of the substrate;
wherein the first touch electrode and the second touch electrode are both electrically connected to a same flexible printed circuit film.

15. The method of claim 14, further comprising:
forming a first electrode pad on the first surface of the substrate;
forming a second electrode pad on the first surface of the substrate;
forming a contact electrode;
forming a first connection line on the first surface of the substrate, the first connection line electrically connecting the first touch electrode and the first electrode pad; and
forming a second connection line on the second surface of the substrate, the second connection line electrically connecting the second touch electrode on the second surface of the substrate and the second electrode pad on the first surface of the substrate via the contact electrode.

16. The method of claim 15, wherein the first electrode pad and the second electrode pad are formed in an area on the first surface of the substrate where an image is not displayed.

17. The method of claim 15, wherein the second electrode pad is formed at any corners of the substrate and the first electrode pad is formed at a position between the corners of the substrate at which the second electrode pad is formed.

18. The method of claim 15, further comprising:
forming a contact hole in a predetermined region including a portion of the substrate, a portion of the second electrode pad, and a portion of the other end of the second connection line, wherein the contact electrode is formed inside the contact hole.

19. A display device comprising:
a touch panel;
a flexible printed circuit (FPC) film connected to the touch panel; and
a display panel formed under the touch panel;
wherein the touch panel includes:
a substrate;
a first touch electrode on a first surface of the substrate; and
a second touch electrode on a second surface of the substrate;
wherein the first touch electrode and the second touch electrode are both electrically connected to the same FPC film.

20. The display device of claim 19, wherein the display panel is formed of an organic light emitting display panel, and the substrate of the touch panel is formed of a moisture prevention film for preventing moisture permeation.
